(19) United States
(12) Patent Application Publication
(10) Pub. No.: US 2020/0388818 A1
(43) Pub. Date: Dec. 10, 2020

(54) SECONDARY BATTERY AND PROTECTION DEVICE THEREOF

(71) Applicant: Polytronics Technology Corp., Hsinchu (TW)

(72) Inventors: Tsung Min SU, Hsinchu City (TW); Chia Mao CHEN, Ji'an Township (TW); David Shau Chew WANG, TAIPEI CITY (TW)

(21) Appl. No.: 16/593,261

(22) Filed: Oct. 4, 2019

(30) Foreign Application Priority Data
Jun. 10, 2019 (TW) 108119877

(51) Int. Cl. H01M 2/34; H02J 7/00; H01M 10/42

(52) U.S. Cl. CPC H01M 2/348; H02J 7/0029; H01M 2010/4271; H02J 2007/0039; H01M 2200/103; H01M 10/425

(57) ABSTRACT

A secondary battery connecting to an external circuit through a first output terminal and a second output terminal. The secondary battery comprises an accumulator, a plurality of protective circuits and a switch element. Each of the protective circuits comprises two fuses connected in series to form a series circuit, a heater for blowing the fuses and a rectifier element in parallel connection to the heater. The series circuits of the two fuses are connected to each other in parallel. One end of the rectifier and the heater is connected to a junction between the two fuses, and another end of u) the rectifier and the heater connect to the switch element. One of the two fuses of each of the protective circuits connects to the first output terminal, and the switch element connects to the second output terminal.

### BACKGROUND OF THE INVENTION

### (1) Field of the Invention

The present application relates to a field of a rechargeable/dischargeable secondary battery, and more specifically, to a secondary battery and its protection device.

### (2) Description of the Related Art

A secondary battery in a mobile phone or a portable laptop computer uses a secondary battery, such as a lithium battery, is associated with a protection circuit. With the increase of charging capacity, the protection circuit becomes more complicated and has more requirement. Recently, there is a need of protection circuits in parallel connection to be adapted to higher rated currents.

FIG. 1 shows a known secondary battery 101 including a charging/discharging accumulator 105, a switch element 104, a control circuit 106 and three protection circuits U1, U2 and U3. The secondary battery device 101 further comprises first and second output terminals 111, 112 between which an external circuit 110 consisting of a load or a DC voltage source is connected. When the accumulator 105 has not been charged and the external circuit 110 consisting of a DC voltage source is connected between the first and second output terminals 111, 112, the accumulator 105 becomes charged by the external circuit 110. Conversely, when the accumulator 105 has been charged and an external circuit 110 consisting of a load such as a portable computer is connected between the first and second output terminals 111, 112, a power is supplied to the external circuit 110 from the accumulator 105 through fuses because the first output terminal 111 supplies a positive voltage with respect to the second output terminal 112 that is at ground potential.

Each protection circuit U1, U2 or U3 contains a heater and two fuses in series connection. The two fuses connect to the first output terminal 111 and the positive terminal of the accumulator 105. One end of the heater is connected to a junction at which the two fuses are connected to each other while the other end of the heater is connected to the second output terminal 112 and the negative terminal of the accumulator 105 via the switch element 104. The heater of the protection circuit U1, U2 or U3 comprises two resistance heating elements in parallel connection. The switch element 104 is controlled by the control circuit 106. When the control circuit 106 detects overvoltage between the first and second output terminals 111, 112 and turns on the switch element 104, a current supplied from the external circuit 110 and a current supplied from the accumulator 105 flow through the left and right fuses respectively. Both currents flow through the resistance heating elements in the heater, whereby they heat up. The resistance heating is elements are located near the fuses, and the fuses are blown by the heat from the resistance heating elements. As a result, both the current flowing from the external circuit 110 and the current discharged from the accumulator 105 are stopped.

If a short circuit occurs between the first and second output terminals 111, 112, however, the control circuit 106 does not operate and the switch element 104 remains off while the accumulator 105 becomes short-circuited at both ends and a short-circuit current is discharged from the accumulator 105. The short-circuit current flows through the two fuses whereby the fuses heat up. However, it is unpredictable which of the two fuses is blown, i.e., it cannot be determined whether the fuse on the side of the accumulator 105, the fuse on the side of the first output terminal 111, or both are blown.

If the fuses on the side of the accumulator 105 were blown in all the protective circuits U1-U3, the positive terminal of the accumulator 105 become completely disconnected so that the accumulator 105 stops discharging. If the fuses on the side of the first output terminal 111 were blown in all the protective circuits U1-U3, the first output terminal 111 is disconnected from all the protective circuits U1-U3, while the positive output terminal of the accumulator 105 is connected to only the switch element 104. In this case, the accumulator 105 stops discharging because the switch element 104 is not turned on.

As described above, the short-circuit current stops when all the counterparts of pairs of fuses on either one side were blown in all the protective circuits U1-U3. However, if the fuse on the side of the first output terminal 111 is blown in the protective circuit U1 and the fuse on the side of the accumulator 105 is blown in the protective circuit U2 as shown in FIG. 2, a residual current I₁₀₁ continues to flow because the positive terminal of the accumulator 105 is connected to the first output terminal 111 via the remaining fuse on the side of the accumulator 105 and the heater in U1, the remaining fuse on the side of the first output terminal 111 and the heater in U2. Because this residual current I₁₀₁ is a small current limited by is the resistance values of two heaters, each heater does not heat up enough to blow the remaining fuses. Furthermore, the fuses themselves do not heat up enough to be blown. This residual current I₁₀₁ does not stop until the accumulator 105 completes discharging.

As shown in FIG. 3, U.S. Pat. No. 7,333,315 discloses a secondary battery 102 of which the circuit is similar to the aforesaid secondary battery 101 except the terminals t_{c} of the heaters of U1-U3 further connecting to diodes D1-D3. Because the diodes D1-D3 allow current to flow in a single direction, the current goes through the heaters and diodes D1-D3 to flow out of the protection circuits U1-U3 and cannot reversely flow into the heaters from the diodes D1-D3. Compared to the circuit of FIG. 2, the protection circuit U2 of FIG. 3 no longer exists a current path entering the heater and therefore residual current can be avoided. However, the diodes D1-D3 are usually disposed outside of the protection circuits U1-U3, resulting in circuit complex and being unfavorable to modularization.

### SUMMARY OF THE INVENTION

The present application provides a solution to solve residual current issue for a secondary battery with protection circuits in parallel connection. A rectifier element is added in the protection circuit, so that an accumulator can still provide sufficient current capable of blowing the remaining fuses to cease current flowing therethrough.

In accordance with a first aspect of the present application, a secondary battery connecting to an external circuit through a first output terminal and a second output terminal is disclosed. The secondary battery comprises an accumulator, a plurality of protective circuits and a switch element. Each of the protective circuits comprises two fuses connected in series to form a series circuit, a heater for blowing the fuses and a rectifier element in parallel connection to the heater. The series circuits of the two fuses are connected to each other in parallel. One end of the rectifier and the heater is connected to a junction between the two fuses, and another end of the is rectifier and the heater is connected the switch element. One of the two fuses of each of the protective circuits is connected to the first output terminal, and the switch element is connected to the second output terminal.

In an embodiment, the rectifier element is a diode.

In an embodiment, if the diode is forward-biased, current does not go through the heater in parallel connection thereto.

In an embodiment, an anode of the diode connects to the switch element, a cathode of the diode connects to the junction between the two fuses of the protection circuit.

In an embodiment, the series circuit of the two fuses connects to a positive terminal of the accumulator.

In an embodiment, a cathode of the diode connects to the switch element, an anode of the diode connects to the junction between the two fuses of the protection circuit.

In an embodiment, the series circuit of the two fuses connects to a negative terminal of the accumulator.

In an embodiment, the rectifier element is a metal-oxide-semiconductor (MOS) transistor.

In an embodiment, the secondary battery further comprises a control circuit to control the switch element. When the control circuit detects an abnormality, the control circuit sends a signal to turn on the switch element.

In an embodiment, if blown fuses of the protection circuits are not on the same side, current goes through the heater of the protection circuit in which the fuse connecting to the first output terminal is blown and the fuse connecting to the accumulator is not blown so as to blow the fuse connecting to the accumulator.

In accordance with a second aspect of the present application, a protection device of a secondary battery is disclosed. The protection device is may be a SMD device. A plurality of protection devices are in parallel connection between the accumulator and the external circuit to provide over-current and over-voltage protection. The protection device comprises two fuses, a heater and a rectifier element. The two fuses connect to a junction to form a series circuit. Two ends of the series circuit connect to a first external electrode and a second external electrode. The heater is configured to heat and blow the fuses. One end of the heater connects to the junction, and another end connects to a third external electrode. The rectifier element and the heater are connected in parallel.

In an embodiment, the rectifier element is a diode.

In an embodiment, an anode of the diode connects to the third external electrode, and a cathode of the diode connects to the junction.

A secondary battery of the present application comprises multiple protection circuits in parallel connection. The protection circuit has a rectifier element and a heater in parallel connection. When the rectifier element is forward-biased, current goes through the rectifier element rather than the heater. As a result, the voltages across the heaters of other protection circuits keep the same so that the heaters still heat up to blow the unblown fuses. As a result, fuses are blown at same side of the protection circuits to provide effective over-current or over-voltage protection.

### BRIEF DESCRIPTION OF THE DRAWINGS

The present application will be described according to the appended drawings in which:

FIG. 1 shows a circuit diagram of a known secondary battery;

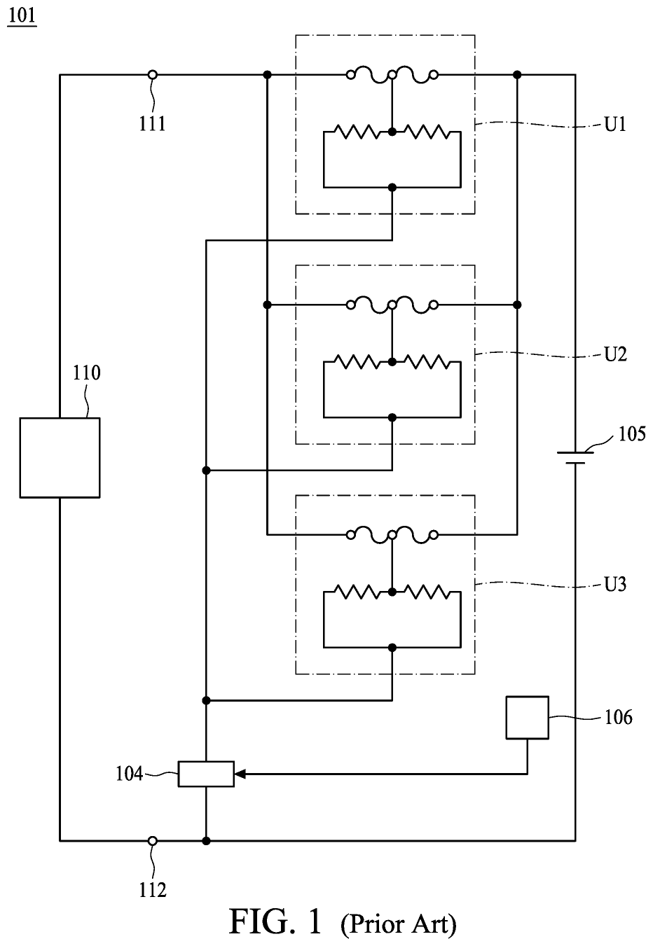

FIG. 2 shows residual current occurs in the secondary battery of FIG. 1;

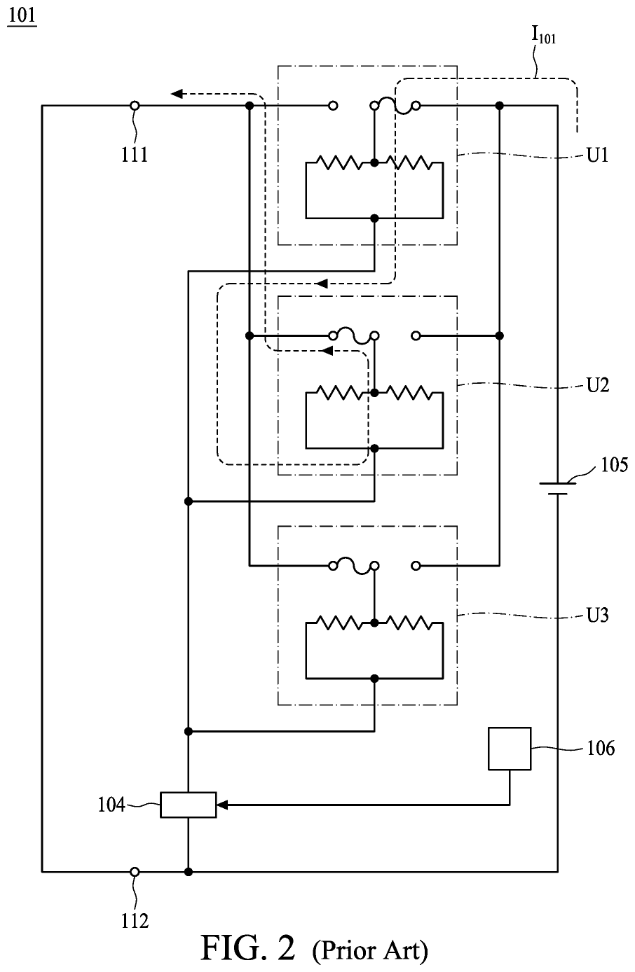

FIG. 3 shows a circuit diagram of another known secondary battery;

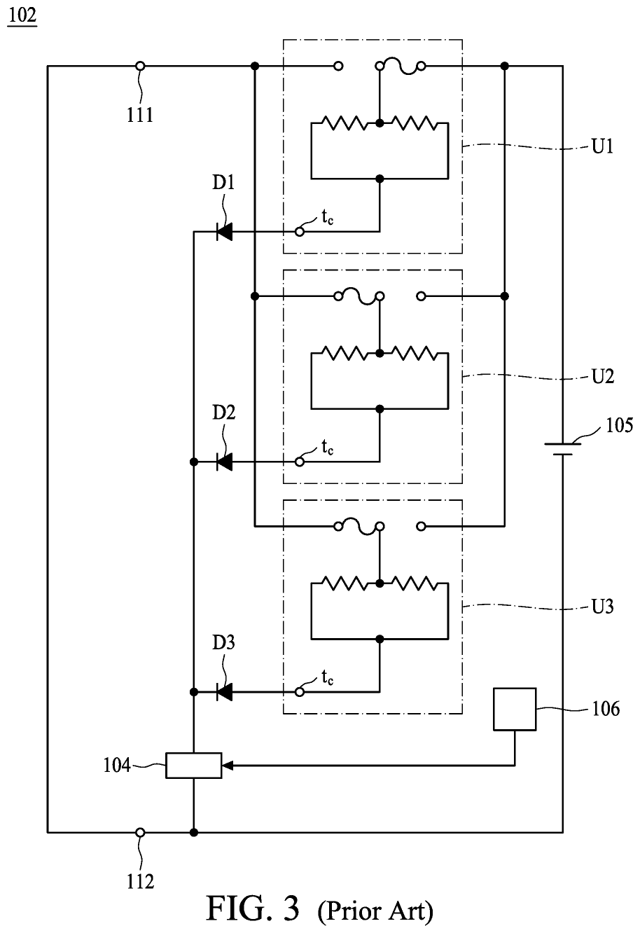

FIG. 4 shows a circuit diagram in accordance with an embodiment of the present application;

FIG. 5 shows a current path of the secondary battery of FIG. 4 in which some fuses are blown;

FIG. 6 shows the consequence of the current in FIG. 5;

FIG. 7 shows a circuit diagram of a secondary battery in accordance with another embodiment of the present application;

FIG. 8 shows a circuit diagram of a secondary battery in accordance with yet another embodiment of the present application;

FIG. 9 shows a protection device of a secondary battery in accordance with an embodiment of the present application;

FIG. 10 shows a circuit diagram of a secondary battery in accordance with still another embodiment of the present application; and

FIG. 11 shows a current path of the secondary battery of FIG. 10 in which some fuses are blown.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

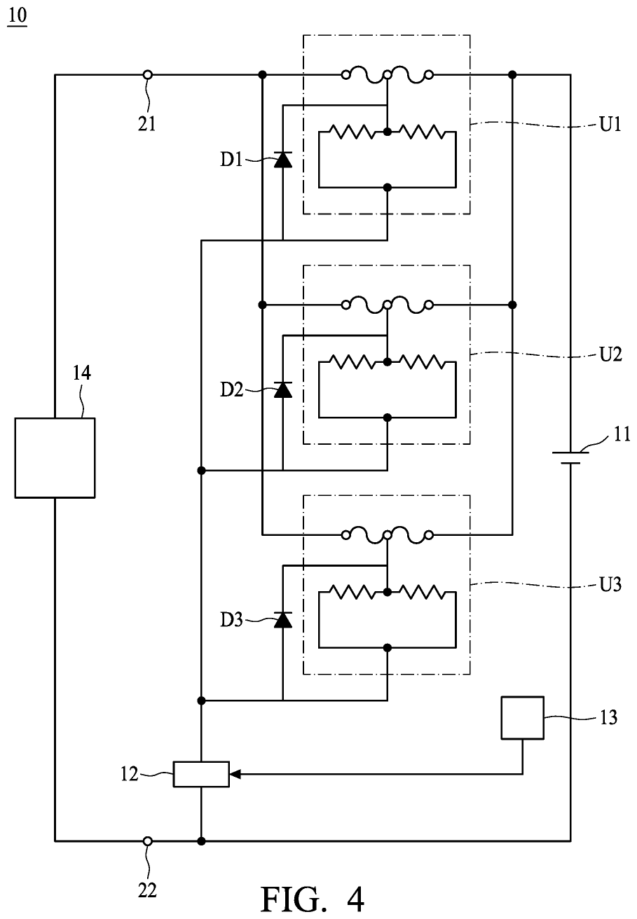

FIG. 4 shows circuit diagram of a secondary battery in accordance with an embodiment of the present application. A secondary battery 10 comprises an accumulator 11, multiple protection circuits U1, U2 and U3, a switch element 12 and a control circuit 13. The protection circuit U1 is comprises two fuses in series connection, a heater with one end connecting to a junction between the two fuses and a rectifier element D1 in parallel connection to the heater. The protection circuit U2 comprises two fuses in series connection, a heater with one end connecting to a junction between the two fuses and a rectifier element D2 in parallel connection to the heater. The protection circuit U3 comprises two fuses in series connection, a heater with one end connecting to a junction between the two fuses and a rectifier element D3 in parallel connection to the heater. The protection circuits U1, U2 and U3 have substantially equivalent interior layout. The series circuits of fuses in U1, U2 and U3 are connected in parallel. In an embodiment, the heater comprises two resistance heating elements in parallel connection. The switch element 12 connects to the heaters and the rectifier elements D1, D2 and D3 of the protection circuits U1, U2 and U3. In an embodiment, the rectifier element D1, D2 and D3 are diodes, e.g., Schottky diodes. The rectifier element D1, D2 and D3 may be other devices allowing current to flow in one direction, e.g., a MOS transistor. Anodes of the rectifier elements D1, D2 and D3 connect to the switch element 12, and electrically connect to the second output terminal 22 and the negative terminal of the accumulator 11 through the switch element 12. Cathodes of the rectifier elements D1, D2 and D3 connect to junctions between two fuses of the protection circuits U1, U2 and U3. Because diodes only allow current to flow in one direction, current must flow to junctions of the two fuses of the protection circuits U1, U2 and U3 and cannot flow reversely.

The secondary battery 10 comprises a first output terminal 21 and a second output terminal 22. An external circuit 14 of a load or a DC voltage source is connected between the first output terminal 21 and the second output terminal 22. The accumulator 11 is chargeable/dischargeable, so that when it has not been charged and an external circuit 14 consisting of a DC voltage source is connected between the first and second output terminals 21, 22, the accumulator 11 becomes charged with a charging current supplied from the external circuit 14. When the accumulator 11 has already is been charged, the second output terminal 22 is grounded, the first output terminal 21 is at a positive voltage, and an external circuit 14 consisting of a load, e.g., a laptop computer, is connected between the first and second output terminals 21, 22, the accumulator 11 starts discharging and a discharging current is supplied to the external circuit 14. When a short circuit occurs between the first and second output terminals 21, 22 and a large short-circuit current flows through the fuses in each protective circuit, the fuses heat up and at least one fuse is blown.

The circuit of two fuses in series connection of each protection circuit U1-U3 connects to the first output terminal 21 and the positive terminal of the accumulator 11, one end of the heater of each protection circuit connects to the junction between two fuses, and another end of heater connects to the second output terminal 22 and the negative terminal of the accumulator 11. The switch element 12 is controlled by the control circuit 13. When the control circuit 13 detects overvoltage between the first output terminal 21 and the second output terminal 22, the control circuit 13 sends a signal to the switch element 12 to turn on the switch element 12. Current from the external circuit 14 and current from the accumulator 11 flow through left fuse and right fuse, respectively. Ideally, the two currents flow through the resistance heating elements of the heater to generate heat. The resistance heating elements of the heater are disposed at vicinity of the fuses to blow the fuses, and as a result the current from the external circuit 14 and discharge current from the accumulator 11 are ceased.

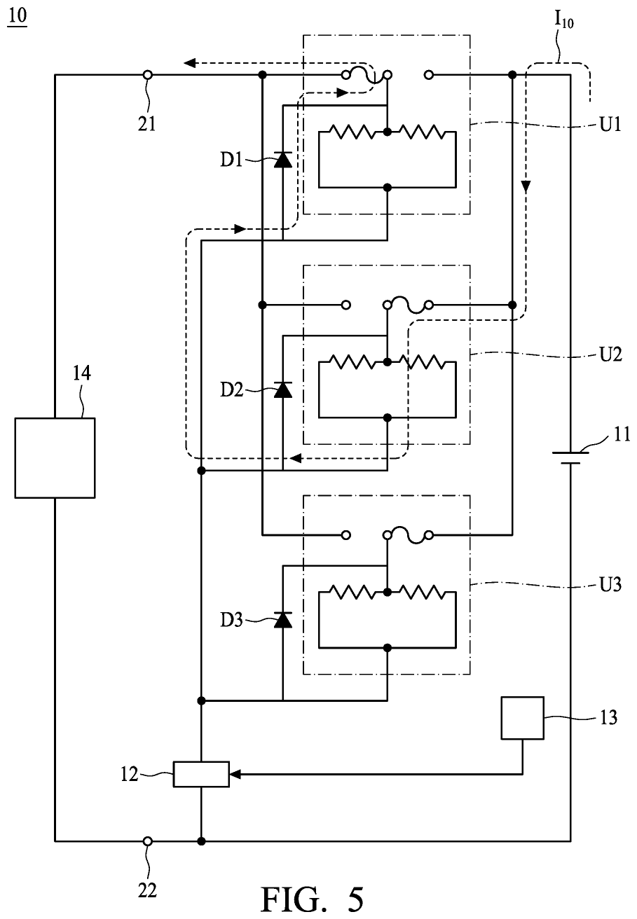

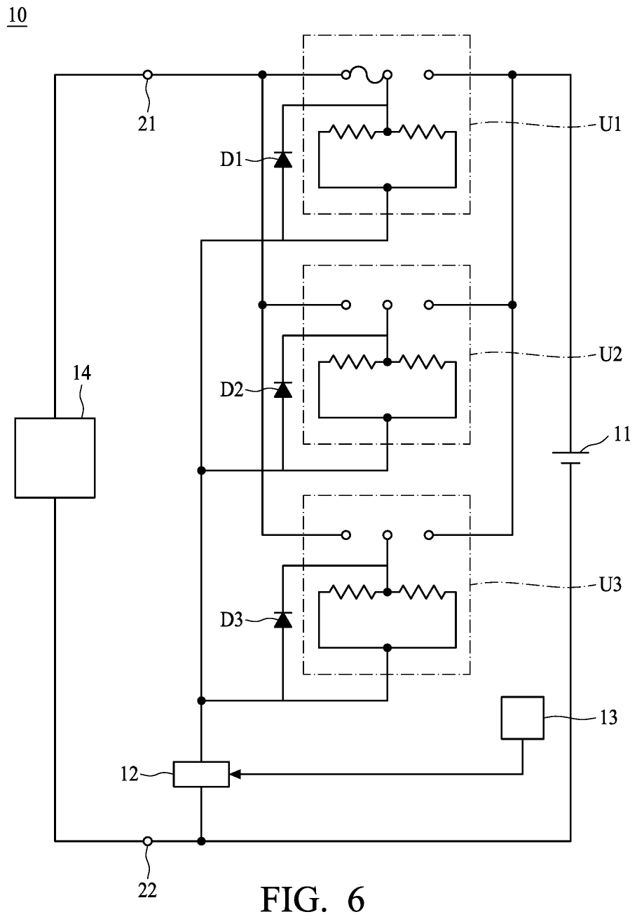

When the switch element 12 turns on, current flows through the resistance heating elements which heat up to blow the fuses. However, it is unpredictable which one of the fuse connecting to the first output terminal 21 and the fuse connecting to the accumulator 11 is blown. In FIG. 5, if the fuse of the protection circuit U1 at the side close to the accumulator 11 is blown and the fuse of the protection circuit U2 at the side close to the first output terminal 21 is blown, a conductive path exists from the positive terminal of the accumulator 11, the unblown fuse at the right side and the is heater of the protection circuit U2, the rectifier element D1 of the protection circuit U1, the fuse at the left side of the protection circuit U1, the first output terminal 21 to the external circuit 14. As a result, residual current I₁₀ flows from the accumulator 11 to the external circuit 14. In FIG. 6, the heater of the protection circuit U1 has a much larger resistance than the rectifier element D1 and they are in parallel to each other, so that the current goes through the rectifier element D1 with a smaller resistance. The current I₁₀ in FIG. 5 only flows through the heater of the protection circuit U2, and therefore the voltage across the heater of U2 sustains and therefore the heater still generates heat to blow the fuse of the protection circuit U2 at the side close to the accumulator 11. Similarly, the protection circuit U3 has a blown fuse at the side close to the first output terminal 21 and the voltages across the heater of U3 and the heater of U2 in parallel connection are the same, and therefore the heater of U3 can blow the fuse at the side of the accumulator 11. As a result, the fuse at the right side of each of the protection circuits U1-U3 is blown, and the accumulator 11 no longer outputs current to the external circuit 14, i.e., no more discharging.

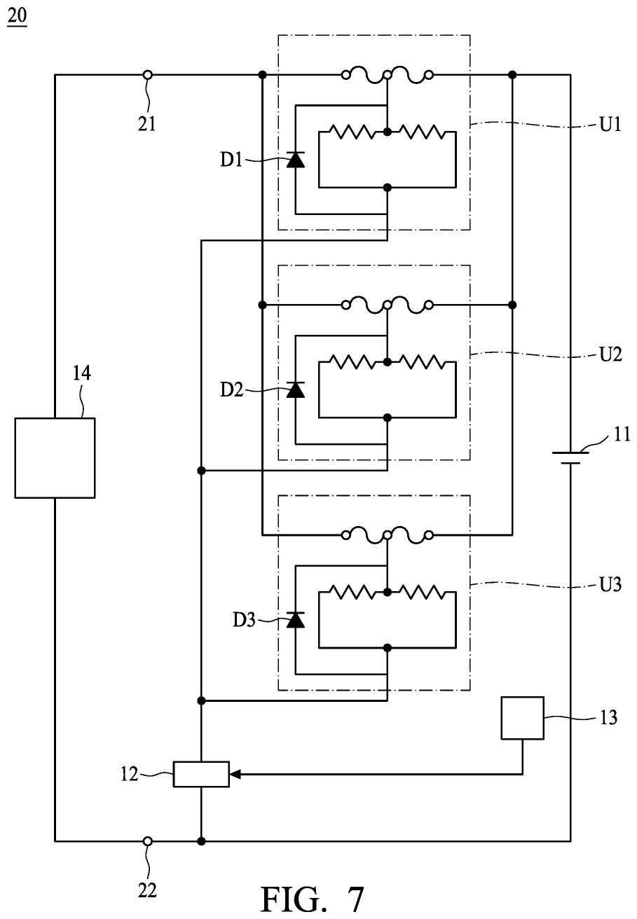

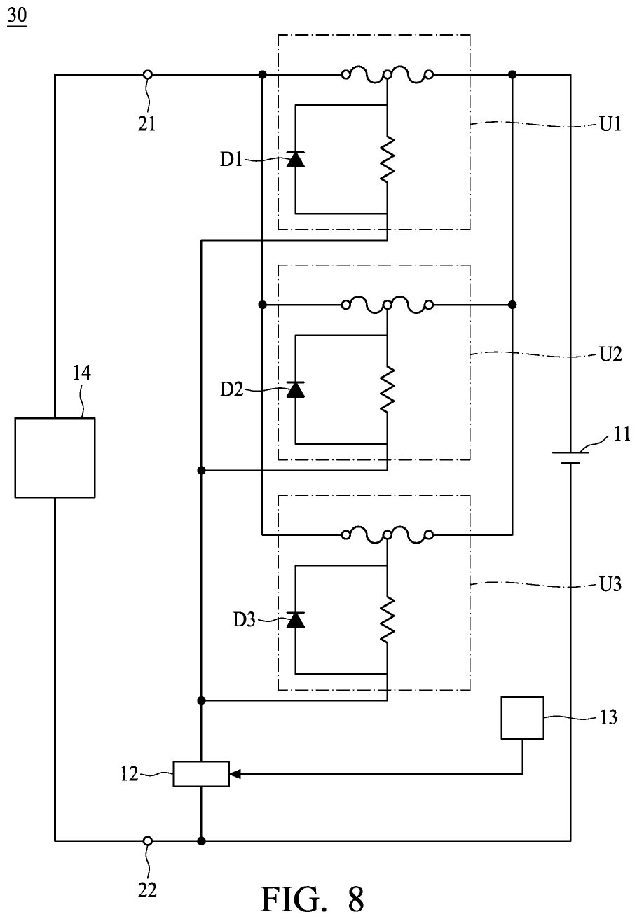

The protection circuits U1-U3 have been commercialized to protection devices of three terminals. Each protection device contains fuses and a heater. In an embodiment, the rectifier elements D1-D3 are integrated into the protection circuits U1-U3, as shown in FIG. 7 illustrating a secondary battery 20. In FIG. 7, each of the protection devices U1-U3 comprises two fuses, a heater and a rectifier element D1, D2 or D3. The heater comprises two resistance heating elements in parallel to each other. In the protection circuit U1, a heater and the rectifier element D1 are in parallel connection. In the protection circuit U2, a heater and the rectifier element D2 are in parallel connection. In the protection circuit U3, a heater and the rectifier element D3 are in parallel connection. In an embodiment, the heater may use one resistance heating element to heat and blow the fuses as shown in FIG. 8 illustrating a secondary battery 30.

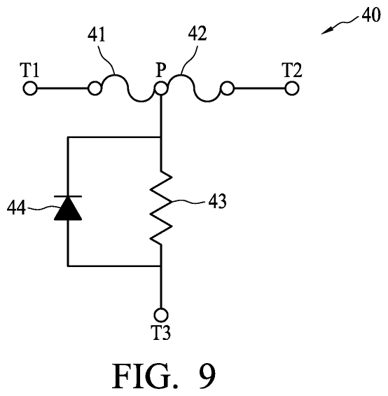

The protection circuit U1, U2 or U3 in FIG. 8 can be implemented by a protection device with external electrodes, e.g., a surface mountable device (SMD). In FIG. 9, a protection device 40 of a secondary battery comprises two fuses 41, 42, a heater 43 and a rectifier element 44. The fuse 41 and the fuse 42 connect to a junction “P” to form a series circuit. The series circuit has two ends connecting to a first external terminal T1 and a second external terminal T2. The heater 43 is close to the fuses 41 and 42 to heat and blow the fuses 41, 42. The heater 43 has an end connecting to the junction “P” and another end connecting to a third external terminal T3. The rectifier element 44 is in parallel to the heater 43. In this embodiment, the rectifier element 44 is a diode of which an anode connects to the third external terminal T3 and a cathode connects to the junction “P.” Alternatively, the heater may comprise two resistance heating elements as shown in the protection circuit U1 U2 or U3 in FIG. 7.

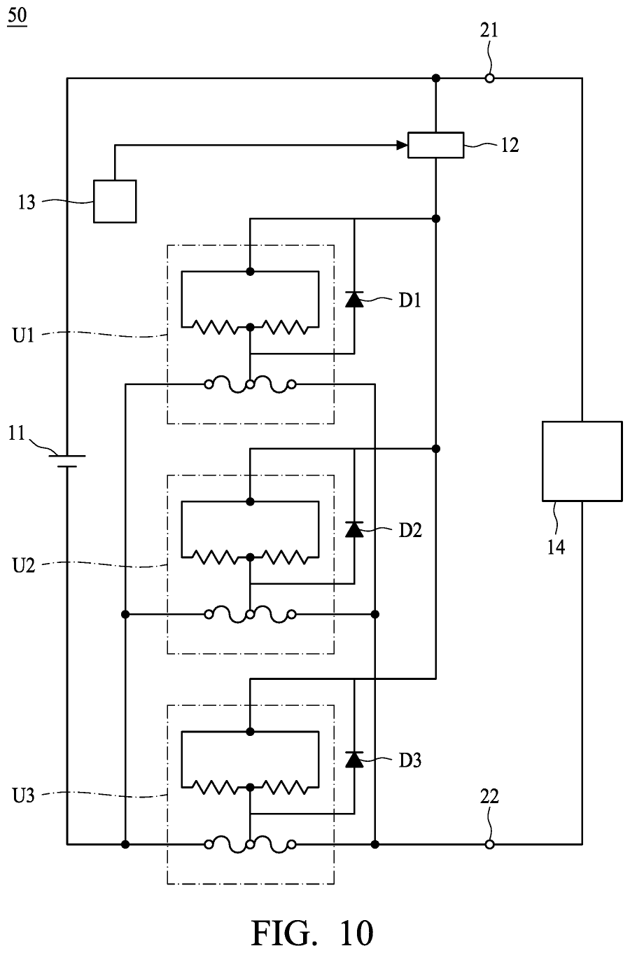

FIG. 10 shows a circuit diagram of a secondary battery in accordance with still another embodiment of the present application. A secondary battery 50 comprises an accumulator 11, protection circuits U1-U3, a switch element 12 and a control circuit 13. An external circuit 14 consisting of a load of a DC voltage source connects to a first output terminal 21 and a second output terminal 22. Each of the protection circuits U1-U3 comprises two fuses in series connection, a heater connecting to a junction between the two fuses, and a rectifier element D1, D2 or D3 in parallel connection to the heater. The protection circuits U1-U3 are substantially equivalent and the series circuits of two fuses in U1-U3 are connected in parallel. The heater comprises two resistance heating elements in parallel to each other. The switch element 12 connects to the heaters and the rectifier elements D1-D3 of the protection circuits U1-U3. In an embodiment, the rectifier elements D1-D3 are diodes, e.g., Schottky diodes. Cathodes of the rectifier elements D1-D3 connect to the switch element 12 through which D1-D3 electrically connect to the first output terminal 21 and a positive terminal of the accumulator 11. Anodes of the rectifier elements D1-D3 connect to the junctions of two fuses of the protection circuits U1-U3. Because diodes allow current to flow only in one direction, current must flow from junctions of the two fuses of the protection circuits U1-U3 to the rectifier elements D1-D3 and cannot flow reversely.

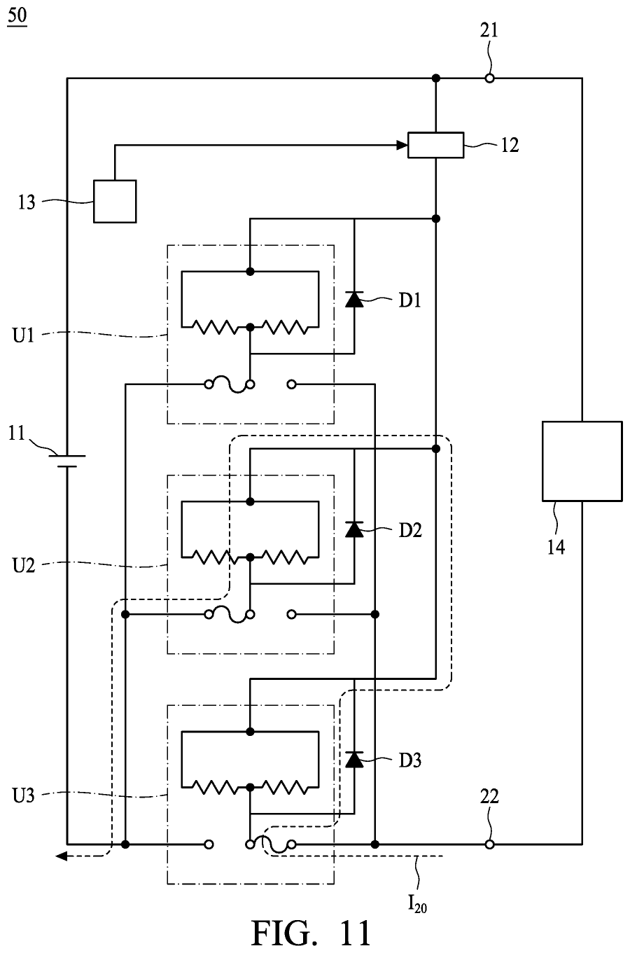

FIG. 11 shows an example that the blown fuses are not at the same side of the protection circuits U1-U3 in the secondary battery 50 in FIG. 10. The blown fuse of the protection circuit U3 is at left side, the blown fuses of U2 and U1 are at right side. When the rectifier element D3 is forward-bias. A current I₂₀ goes through the rectifier element D3 rather than the heater in parallel to the rectifier element D3. In the protection circuit U2, I₂₀ flows through the heater in parallel to the rectifier element D2 because current cannot go through the rectifier element D2, and then goes to the negative terminal of the accumulator 11. Similarly, I₂₀ only flows through the heater of the protection circuit U2, the voltage across the heater sustains. Therefore, the heater is still capable of generating heat to blow the left fuse in the protection circuit U2. The protection circuit U1 is in parallel to the protection circuit U2, the heater in U1 also can blow the left fuse in the protection circuit U1. As a result, all the fuses blown at the same side (left side) in the protection circuits U1-U3 can be obtained.

The above-mentioned embodiments use three protection circuits in parallel connection; however the number of protection circuits in parallel connection can be altered as desired and associate with rectifier elements to blow the fuses at the same side to cease current flow if abnormality occurs.

The above-described embodiments of the present invention are intended to be illustrative only. Numerous alternative embodiments may be devised by persons skilled in the art without departing from the scope of the following claims.

What is claimed is:

1. A secondary battery connecting to an external circuit through a first output terminal and a second output terminal, comprising:
an accumulator;
a plurality of protection circuits, each of the protective circuits comprising two fuses, a heater and a rectifier, the heater being configured to heat and blow the two fuses, the two fuses being in series connection to form a series circuit, the heater and the rectifier element connecting to a junction between the two fuses, the heater and the rectifier element being in parallel connection, the series circuits of the protection circuits being in parallel to each other; and
a switch element connecting to the heater and the rectifier element;
wherein one of the two fuses of each of the protective circuits connects to the first output terminal, and the switch element connects to the is second output terminal.

2. The secondary battery of claim 1, wherein the rectifier element is a diode.

3. The secondary battery of claim 2, wherein when the diode is forward-biased, current does not go through the rectifier element in parallel to the diode.

4. The secondary battery of claim 2, wherein the diode has an anode connecting to the switch element and a cathode connecting to a junction between the two fuses of the protection circuit.

5. The secondary battery of claim 4, wherein the series circuit of the two fuses connects to a positive terminal of the accumulator.

6. The secondary battery of claim 2, wherein the diode has a cathode connecting to the switch element and an anode connecting to a junction between the two fuses of the protection device.

7. The secondary battery of claim 6, wherein the series circuit of the two fuses connects to a negative terminal of the accumulator.

8. The secondary battery of claim 1, wherein the rectifier element is a metal-oxide-semiconductor transistor.

9. The secondary battery of claim 1, further comprises a control circuit to control the switch element, the control circuit sending a signal to turn on the switch element when abnormality being detected.

10. The secondary battery of claim 1, wherein if blown fuses of the protection circuits are not at the same side, current goes through the heater of the protection circuit in which the fuse connecting to the first output terminal is blown and the fuse connecting to the accumulator is not blown so as to blow the fuse connecting to the accumulator.

11. A protection device of a secondary battery, comprising:
two fuses connecting to a junction to form a series circuit having two ends connecting to a first external terminal and a second external terminal;
a heater for heating and blowing the fuses and having an end connecting to the junction and another end connecting to a third external terminal; and
a rectifier element in parallel connection to the heater.

12. The protection device of claim 11, wherein the rectifier element is a diode.

13. The protection device of claim 12, wherein the diode has an anode connecting to the third external terminal and a cathode connecting to the junction.

14. The protection device of claim 12, wherein the diode has a cathode connecting to the third external terminal and an anode connecting to the junction.

15. The protection device of claim 11, wherein the rectifier element is a metal-oxide-semiconductor transistor.
